(19) United States
(12) Patent Application Publication
(10) Pub. No.: US 2025/0250853 A1
(43) Pub. Date: Aug. 7, 2025

(54) BLIND ASSEMBLY AND METHOD OF INSTALLATION

(71) Applicant: Decor Systems Limited, Doncaster (GB)

(72) Inventor: RICHARD MCCREADIE, DONCASTER (GB)

(21) Appl. No.: 19/042,684

(22) Filed: Jan. 31, 2025

(30) Foreign Application Priority Data
Feb. 2, 2024 (GB) 2401420.1

(51) Int. Cl. E06B 9/42; E06B 9/72; E06B 9/78

(52) U.S. Cl. CPC E06B 9/42; E06B 9/72; E06B 9/78; E06B 2009/785

(57) ABSTRACT

The invention relates to a blind assembly, typically for use in conjunction with a window or windows, and a method of installing the blind assembly. The blind assembly is assembled with a sheet material portion and typically actuation means for the selective movement of the sheet material portion, located within a housing. The housing has an opening through which, when the blind assembly is installed, the sheet material portion can be moved between various user selected positions intermediate an extended configuration and retracted configuration. Prior to and during installation, at least the sheet material portion is retained and typically sealed within the housing in the retracted configuration typically by the provision of sealing means which close the opening so as to minimise the risk of damage to the sheet material portion and actuation means within the housing during transit and installation.

### CROSS REFERENCE TO RELATED APPLICATIONS

This application claims priority under 35 U.S.C. § 119 to Great Britain application No. 2401420.1, filed Feb. 2, 2024, which is herein incorporated by reference in its entirety including without limitation, the specification, claims, and abstract, as well as any figures, tables, or examples thereof.

### SUMMARY

The invention to which this application relates is to the provision of a blind assembly and method of installing the same for use in selectively deploying a sheet material portion of the said blind assembly to a position with respect to a surface, typically, although not necessarily exclusively, a surface of a window, to at least partially block the light passing through the window. The blind assembly typically includes an actuation means acting on a spindle around which the sheet material portion of the blind assembly is wound and unwound as the sheet material portion is moved between a retracted configuration and an extended configuration respectively, and positions in between, by a user to at least partially mask the light passing through a window at which the screen assembly is located.

It is known to provide a deployable blind assembly at a window in order to at least partially block the light passing through the same. Blind assemblies are utilised in various locations as an alternative to, or used in conjunction with, curtains, particularly in domestic residences and office buildings. The sheet material of the blind assemblies may be provided in a variety of opacities to serve various functions. For example, opaque sheet material portions may be installed in bedrooms to ensure the occupants of a room are exposed to minimal light transmission when the sheet material portion is deployed from the window with which the blind assembly is located. Translucent sheet material portions offer reduced glare and privacy through a window and can be well suited for living spaces or offices.

It is common to mount a blind assembly at and above the top edge of a window to enable the sheet material portion to be deployed downwards to cover the same when necessary. The blind assembly actuation means however, is then visible to the occupants of the room where the blind assembly is installed even when it is in a retracted configuration. This may appear unsightly and/or be in contrast to the interior design with which the room has been decorated.

It is known to provide the sheet material portion within a housing to form a blind assembly which is incorporated with or concealed by a ceiling or wall panel. This ensures that, on installation of the blind assembly, the same is substantially concealed. When the ceiling or wall panels are subsequently installed during the decoration or fitting out of a room, the housing assembly is installed with the panels to be integral with the same. Following the installation of the panels, it is common for the walls and/or ceiling to be painted, wallpapered or the like and the sheet material portion is installed within the housing. These separate and distinct operations are often carried out by separate parties, e.g. a joiner, a painter, and a blind installation specialist. This adds a logistical burden to the fitting of the blind assembly given the number of different parties that may be involved, as consequent processes cannot begin until the completion of the previous process or, if performed simultaneously, there can be problems of available space and/or damage is caused to the sheet material portion. There is also subsequent difficulty in assigning responsibility for damages to a blind assembly if it is damaged during one of these processes.

Furthermore, it is often the case that on completion of the installation of the blind assembly, final finishing processes may be required to be applied to the room in which the blind assembly is installed. For example, a painter may apply a second coat of paint to a wall, or an electrician may need to apply some wiring adjacent the blind assembly. As a result, there is again a risk of damage to the sheet material and the blind assembly in general as it may become damaged or be marked by these final finishing processes.

There is therefore a need to provide a blind assembly, and an installation method in a manner which avoids or minimises the conventional problems herein described.

An aim of the present invention is therefore to provide a blind assembly that may be protected during installation and the performance of subsequent processes in the vicinity of the same. A further aim is to allow one party to install the blind assembly in one installation operation.

A further aim of the invention is to provide the blind assembly in a form which minimises the potential for damage to the blind assembly by dust, paint particles, moisture or the like during transport, installation, once the assembly has been installed, and before use.

In a first aspect of the invention, there is provided a blind assembly, including: a housing; a sheet material portion located within the housing along with a actuation means which is configured to be used to selectively deploy the sheet material portion between retracted and extended positions and intermediate positions through an opening of the housing unit; a mounting means to allow the blind assembly to be installed in position with a ceiling and/or wall of a building and wherein the said sheet material portion is retained within the said housing during said installation of the blind assembly at the ceiling and/or wall of a building.

In one embodiment the opening of the housing is provided with a sealing means which acts to retain the said portion of sheet material within the housing. In one embodiment the sealing means also seals the said opening and hence protects the sheet material portion and the interior of the housing generally from the ingress of dust, debris and liquids and potential impact. Preferably the sealing means is only removed when the blind assembly and/or building is ready for use.

Typically the blind assembly includes a flexible sheet material portion such as a fabric material.

In one embodiment the sheet material portion is provided in a retracted configuration within the housing. In one embodiment the sheet material portion is deployable between extended and retracted configurations through the opening of the housing in use.

Typically the sheet material portion includes a weight to anchor the sheet material portion when in the extended configuration.

In one embodiment the flexible sheet material is provided as a roll within the housing when in the retracted configuration.

Typically the roll includes a spindle passing along a central axis of the roll, around which the roll rotates when deploying between the extended and retracted configurations. Typically the spindle is located with at least one mounting member of the housing, wherein the spindle is freely rotatable with respect to the at least one mounting member.

In another embodiment the flexible sheet material is folded within the housing when in the retracted configuration. In another embodiment the sheet material portion is folded in a corrugated manner when in the retracted configuration.

In one embodiment the sheet material portion is in communication with an actuating means, wherein the actuating means drives the deployment and/or retraction of the sheet material portion between the retracted configuration and the extended configuration in use.

Typically the actuating means is at least partially located within the housing so as to be concealed from the exterior of the housing.

In one embodiment the actuating means includes a motorised mechanism electrically connected with a power source.

In one embodiment the power source is a battery located with the motorised mechanism. Typically the battery includes an electrical input port such that the battery is selectively chargeable.

In another embodiment the power source is a mains power source electrically connected with the motorised mechanism via a cable. Typically a flexible cable is provided with the motorised mechanism to be connected with the mains power source in use.

In another embodiment the actuating means includes a manually drivable mechanism. Typically the manually drivable mechanism includes a geared connection in mechanical communication with an elongate member to be pulled by a user in use. Preferably the elongate member is a beaded chain.

Typically, the blind assembly is formed under factory conditions, preferably sealed by the sealing means and then transported to the location of installation. This preferably means that no assembly work is required at said location of installation. In this way, the blind assembly is modular.

In one embodiment the sealing means includes a member selectively retained with the housing across at least a portion of the opening of the housing, such that the sheet material portion is concealed by the sealing means in use and is accessible when the sealing means is removed from the housing.

Preferably the sealing means seals the entire opening of the housing. In this way, the sheet material portion is encapsulated by the housing and sealing means before the sealing means is removed by a user, such that the sheet material portion is protected from the surrounding environment and material that might otherwise damage or discolour the same, such as paint, plaster, dust, water and the like.

In one embodiment the sealing means includes a sealing member located with the housing by a frangible connection.

Typically in this embodiment the connection between the sealing member and the housing is configured such that the member cannot be relocated with the housing once it is removed.

In another embodiment the sealing means includes a sealing member that is selectively located with the housing by a locating means. In this embodiment the locating means is selectively located with and/or removable from the housing.

Typically the sealing member is a semi-rigid member. Preferably the semi-rigid member is formed of PVC or polypropylene material.

In another embodiment the sealing means includes a sealing member adhered to the housing.

Typically the sealing means includes a tab to enable a user to remove the sealing means from the housing in use.

In one embodiment the mounting means includes at least one bracket mounted with the housing, wherein the at least one bracket is retained with a wall and/or ceiling by a retaining means in use. Typically the retaining means is a threaded connection.

In one embodiment the housing is a tubular or box like formation with an opening through which the blind assembly is located. Typically the housing is formed of an extruded aluminium alloy. Typically the longitudinal axes of the spindle of the actuation means, the opening and the housing are parallel.

In one embodiment the housing includes a movable panel configured such that the sheet material portion is accessible when in the retracted position and when the movable panel is moved to an accessing position.

In one embodiment the housing includes a flange member configured such that a ceiling panel and/or a wall panel may be located against the same in use. Typically the flange is configured such that a panel is flush with a face of the housing in which the opening through which the sheet material portion is selectively deployable in use.

In one embodiment a film is located with the housing and is selectively removable by a user in use. Typically the film is adhered to the housing.

In one embodiment the housing includes a locating means for a curtain. Typically the locating means includes at least one rail and/or hooks.

In one embodiment the blind assembly is installed and used adjacent to at least one window.

In another aspect of the invention there is provided a method of installing a blind assembly, the method comprising the steps of locating a housing of the blind assembly with a wall and/or ceiling of a building and installing the assembly via retaining means to the said wall and/or ceiling, wherein the said blind assembly is assembled prior to said installation by locating a sheet material portion of the blind assembly in a retracted configuration in engagement with actuation means located within the interior of said housing and retaining the same within the said housing during installation, and after said installation allowing said sheet material portion to be selectively deployable between a retracted configuration and an extended configuration through an opening of the housing.

Typically the method further includes a step of applying a sealing means to seal the opening of the housing once the blind assembly is formed and so retain and seal the sheet material portion within the housing prior to installation and then removing the sealing means after installation to allow the sheet material portion to be moved through the opening.

Typically the blind assembly includes removable sealing means which close the said opening. Typically the said sealing means are positioned at the time of assembly and are selectively removable and most typically are removed following completion of installation and other works which may be taking place in the vicinity of the installed blind assembly.

While it is intended that the sealing member is in position on the housing during transport to site, installation and the performance of other works and until the blind assembly is intended to be used, it will be appreciated that in certain embodiments the sealing member may be temporarily removed, for example, to allow a particular installation task to be performed, and then repositioned to again close the opening.

### BRIEF DESCRIPTION OF THE DRAWINGS

Specific embodiments of the invention are now described with reference to the accompanying drawings wherein:

FIG. 1 illustrates a perspective view of a blind assembly located adjacent a window in accordance with one embodiment of the invention;

FIG. 2 illustrates a section detail view of a blind assembly in accordance with one embodiment of the invention;

FIGS. 3a-b illustrate a perspective and section view of a blind assembly recessed with a ceiling panel in accordance with one embodiment of the invention;

FIGS. 4a-b illustrate a perspective and section view of a blind assembly semi-recessed with a ceiling panel in accordance with one embodiment of the invention;

FIGS. 5a-b illustrate a perspective and section view of a blind assembly mounted on the underside of a ceiling panel in accordance with one embodiment of the invention;

FIGS. 6a-b illustrate a perspective and section view of a blind assembly including a curtain locating means recessed with a ceiling panel in accordance with one embodiment of the invention;

FIGS. 7a-c illustrate a manual, wired motorised, and wireless motorised actuating mechanism for a blind assembly in accordance with the invention;

FIGS. 8a-c illustrate a silver anodised weight, a powder coated weight and a concealed weight to anchor a sheet material portion in accordance with the invention;

FIGS. 9a-c illustrate an opaque sheet material portion, a translucent sheet material portion, and a privacy sheet material portion in accordance with the invention;

FIGS. 10a-b illustrate a forward roll and reverse roll sheet material portion configuration in accordance with the invention; and

FIG. 11 illustrates a section view of a housing and sealing means in accordance with one embodiment of the invention.

### DETAILED DESCRIPTION

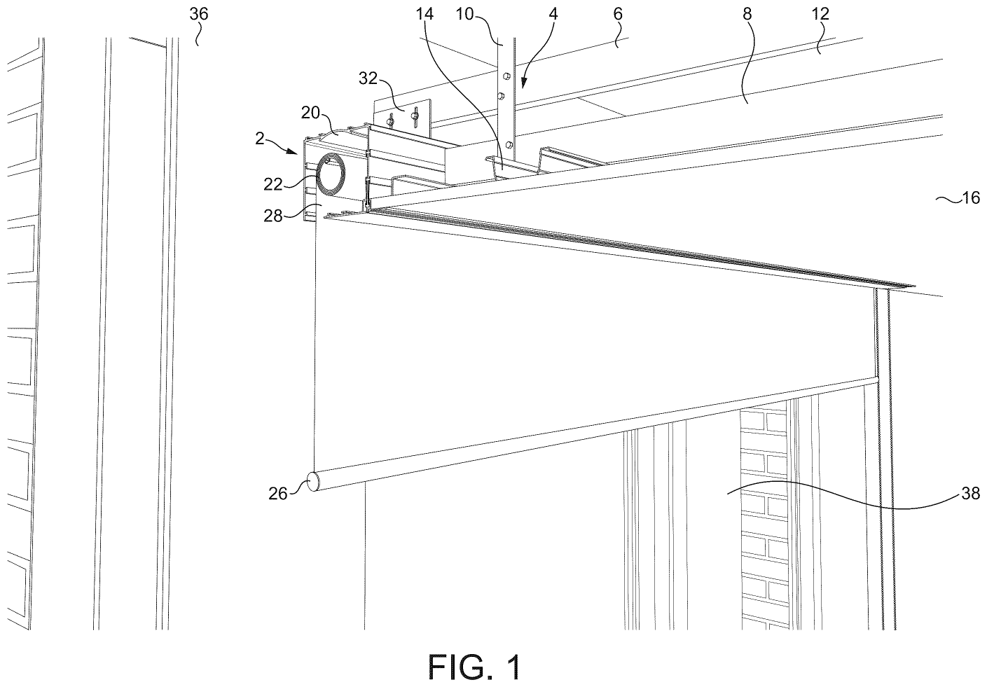

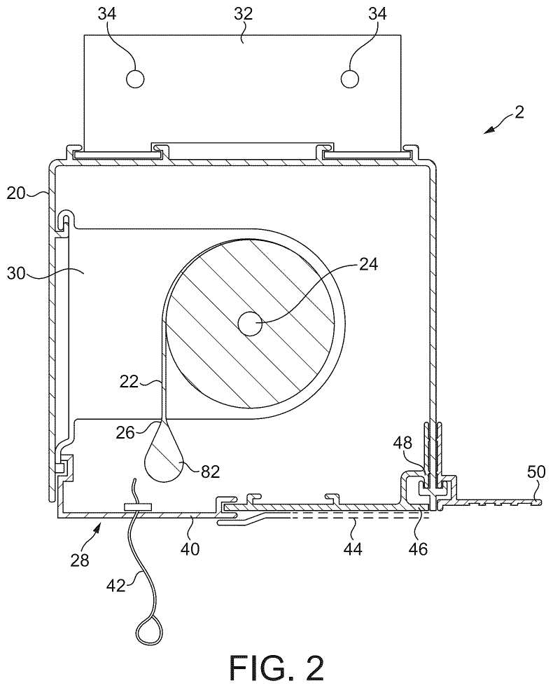

Referring firstly to FIGS. 1 and 2, there is illustrated a blind assembly 2 mounted with a ceiling unit 4. The ceiling unit 4 is comprised of a first and second joist 6, 8 suspended by a hanger 10 from the ceiling 12. A plurality of transverse frames 14 provide structural integrity to parallel joists (not shown). A network of seats (not shown) suspended from the joists and frames form a grid in which a plurality of ceiling panels 16 may be located. Lights may be fitted with the ceiling panels 16, which act to conceal wiring and the like and the ceiling 12 from view from below.

The blind assembly 2 includes a housing 20 formed of an extruded aluminium alloy. The housing 20 is tubular in formation to house a sheet material portion 22 within. The sheet material portion 22 is provided as a roll, rotatable about a central axis of a spindle 24 of an actuation means. When rotated in a first direction, the sheet material portion 22 unrolls and a free end 26 may extend through an opening 28 of the housing 20. When rotated in a second direction, the sheet material portion 22 is rolled back on itself, and the free end 26 is retracted within the housing 20. In this way, when the sheet material portion 22 is fully retracted, it is concealed within the housing 20.

The sheet material portion roll 22 is located within the housing 20 by a pair of mounting plates 30 which each include a rotatable roll end plate (not shown) such that the roll is constrained and freely rotatable with respect to the housing 20 about the central axis 24.

The housing 20 includes a mounting means in the form of a bracket 32. The bracket 32 includes a pair of mounting holes 34 for the location of a retaining bolt therethrough. The bracket 32 is mounted to the joist 6 of the ceiling unit 4 such that the blind assembly 2 is located against an interior wall 36 and above a window 38. In this manner, the sheet material portion 22 may be deployed from the housing 20 to extend across the length of the window 38 and cover the same.

It will be appreciated by the skilled reader that the sheet material portion 22 may alternatively be positioned within the room to act as a partition, a blind for a projector or the like.

The housing opening 28 through which the sheet material portion 22 is deployable is provided with a sealing member 40. The sealing member 40 is located across the opening 28 and retained with the housing 28 by means of a frangible connection. As such, before the sealing member 40 is removed, the sheet material portion 22 is sealed within the housing 20 by the sealing member and housing end caps (not shown) mounted on the open ends of the tubular housing. This provides the advantage that the sealed housing 20 may be installed with the ceiling unit 4, with no risk of damage to the sealed sheet material portion 22 within the housing 20. The surrounding environment can continue to be worked, e.g. the wall 36 may be painted, lights may be wired etc. whilst the sheet material portion 22 is sealed away from dust, paint particles, moisture and the like that may otherwise damage or mark the same.

The sealing member 40 is provided with a pull tab 42 that, when pulled, will break the frangible connections and the sealing member may be removed from the housing 20. The sealing member can then no longer be located with the housing 20 as the frangible connection is broken. In this way, the sealing member 40 provides a visual indication if the sheet material portion 22 has become unsealed. The manufacturer may assemble the blind assembly and test that the same is functional before sealing the same with the sealing member 40. This guarantees that the blind assembly will be undamaged during the installation process until the sealing member 40 is removed and prevents an installer that has damaged the sheet material portion 22 from falsely accusing that the blind assembly was provided by the manufacturer in the damaged condition.

The ease of removal of the sealing member 40, by the provision of the pull tab 42 and frangible connections, allow an end user of the sheet material portion 22 to carry out the unsealing operation. This removes the requirement for the installer to travel back to the assembly 2 when the fitting of the room has been carried out.

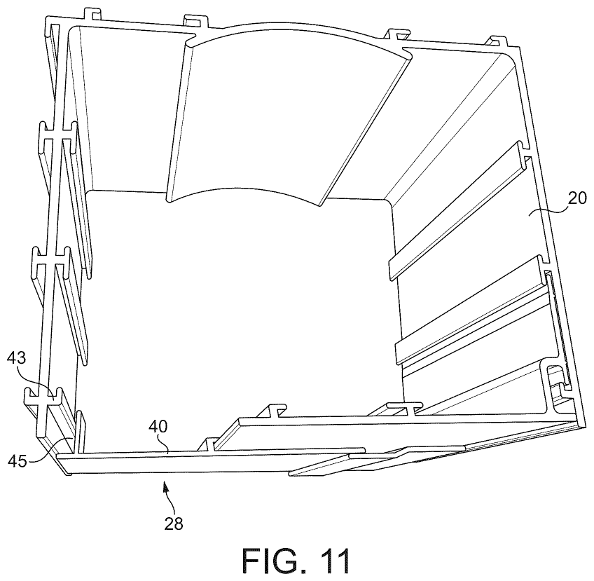

In an alternative embodiment, illustrated in FIG. 11, the sealing member 40 is located with the housing 20 by a locating means, in this embodiment a rail 43 with which a shoulder 45 of the sealing member is contacted. In this embodiment, the sealing member 40 may be slid along the rail 43 along the length of the housing 20 to be removed from an end of the same or otherwise be detached from the rail shoulder to be moved away from the housing and expose the opening 28. The user may then selectively relocate the shoulder 45 with the rail 43 and relocate the sealing member 40 across the opening 28 to conceal a sheet material portion located within the housing in use. In this way, the sealing member 40 is selectively removable and selectively relocatable with the housing in use.

A protective film 44 is provided with the exposed surface of the housing 20 of FIG. 2. This film 44 is self-adhesive and prevents the housing 20 being scratched or marked during installation. This film 44 may be removed by an end user.

The housing 20 includes a movable panel portion 46. The panel 46 is pivotably mounted with the housing about a hinge 48 and is held closed by gravity. Pressing the panel 46 upwards allows the interior of the housing 20, and therefore the housing 20 to be accessed for maintenance and repair.

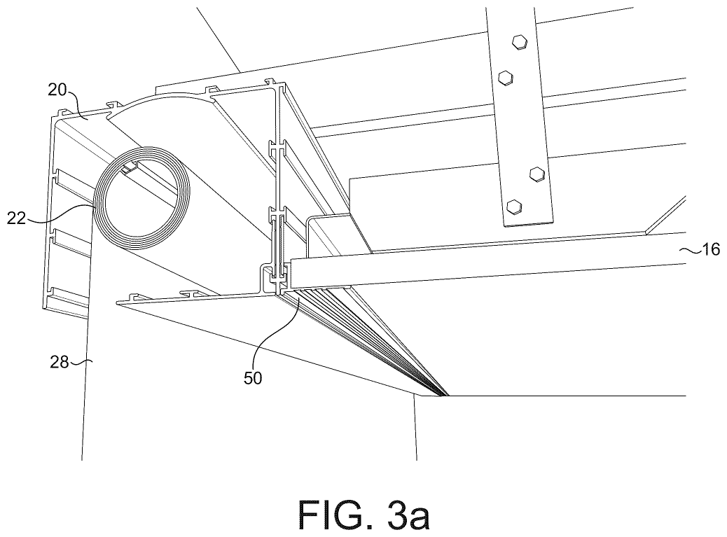

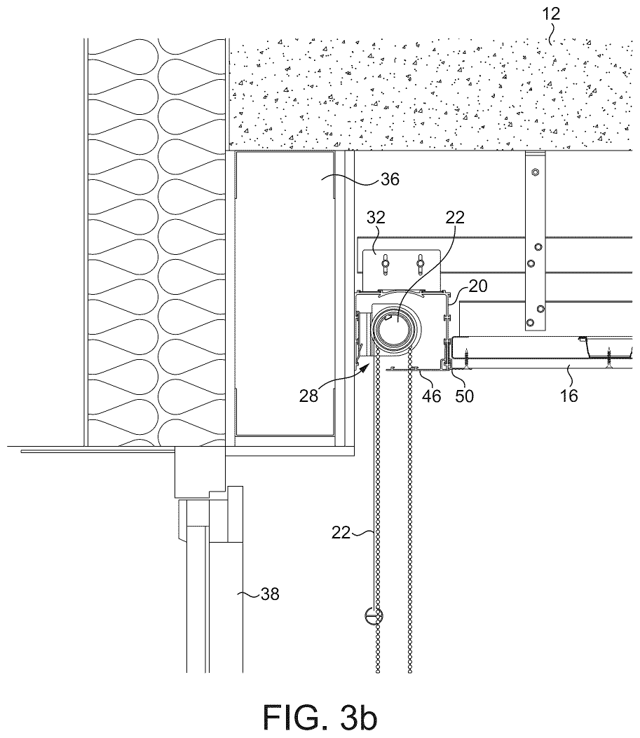

The housing includes a flange 50 that acts as a seat for a ceiling panel 16. In this way, the blind assembly is flush with the neighbouring ceiling panel 16 and recessed into the ceiling unit 14. This is illustrated in more detail in FIGS. 3a-b.

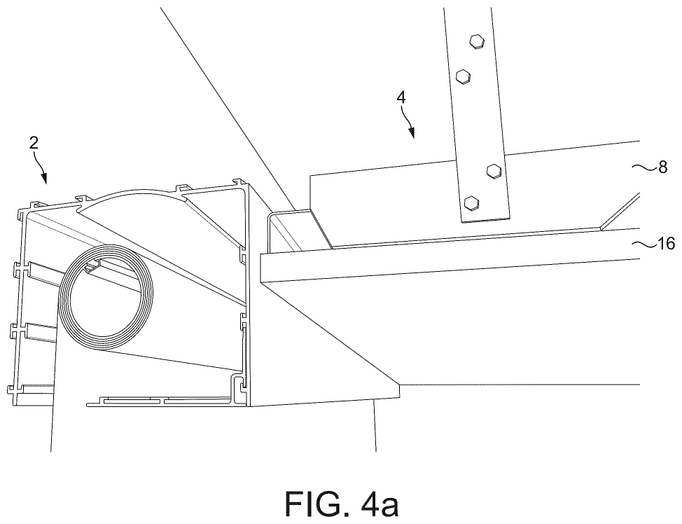

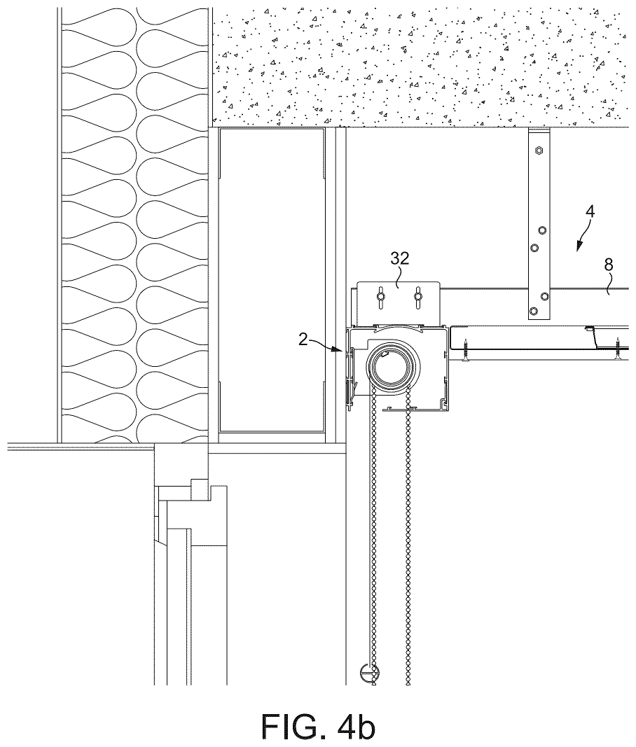

In an alternative embodiment illustrated in FIGS. 4a-b, the ceiling unit 4 comprises one joist 8 to which the ceiling panel 16 is directly mounted. The blind assembly 2 is mounted to the joist 8 by the bracket 32 so as to be partially recessed within the ceiling unit 4.

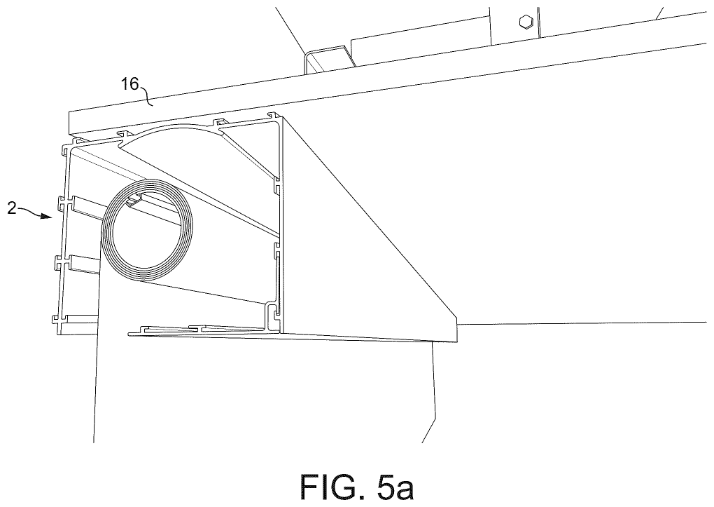

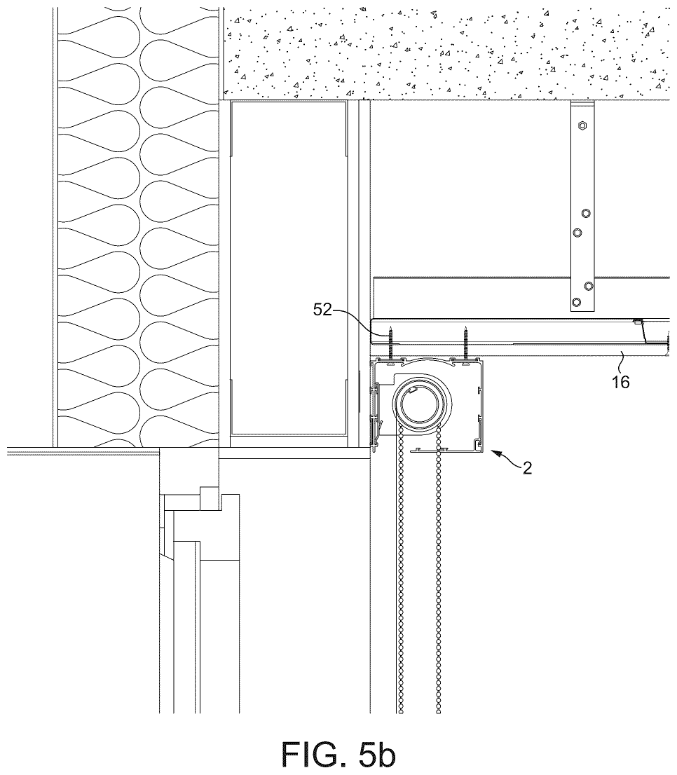

In a yet further embodiment illustrated in FIGS. 5a-b, the blind assembly 2 is mounted directly to the ceiling panel 16 by the provision of multiple screws 52 passing through the housing 20 into the ceiling panel 16. In this embodiment, the housing is not recessed within the ceiling unit 4 and is located on the surface of the same.

The above alternative embodiments illustrate that the housing 20 may therefore be mounted with the ceiling unit 4 in a manner that is recessed, semi recessed or exposed in whatever manner is suitable for the given ceiling unit 4 configuration. In an alternative embodiment, the housing 22 may be mounted with a wall rather than the ceiling.

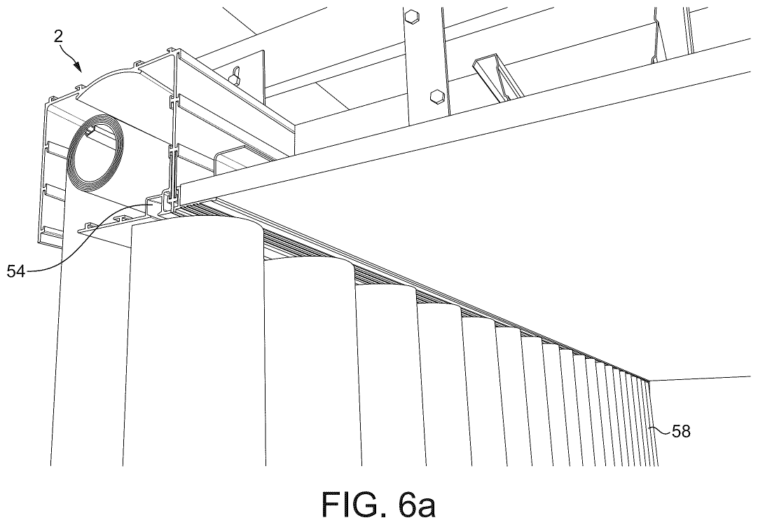

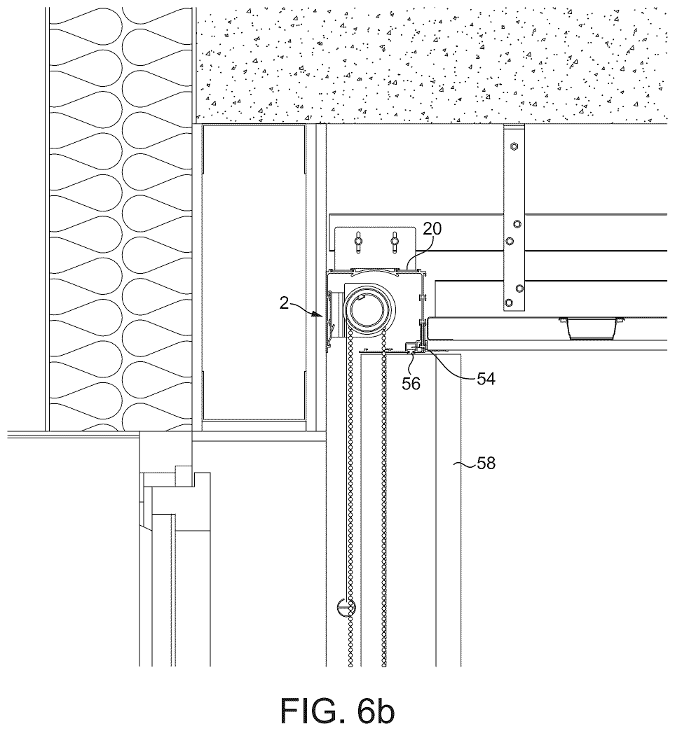

In the embodiment illustrated in FIGS. 6a-b, the housing 20 includes a groove 54 for the location of curtain anchors 56. This allows a curtain 58 to be slidingly located with the housing 20.

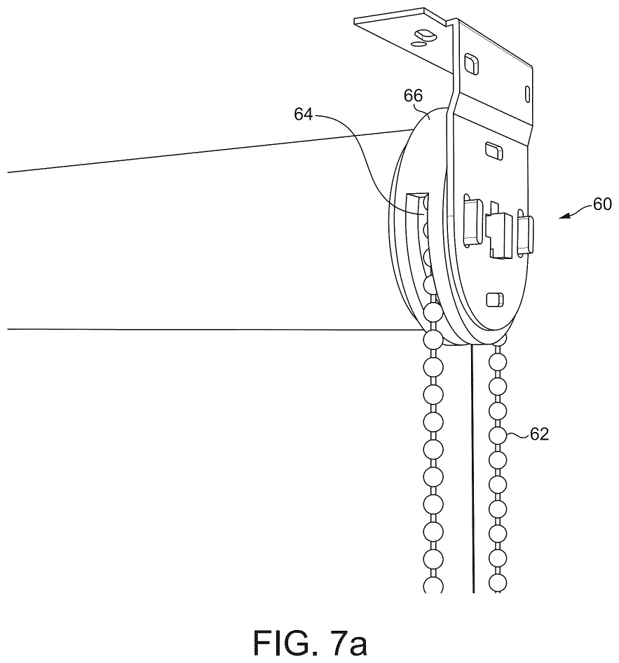

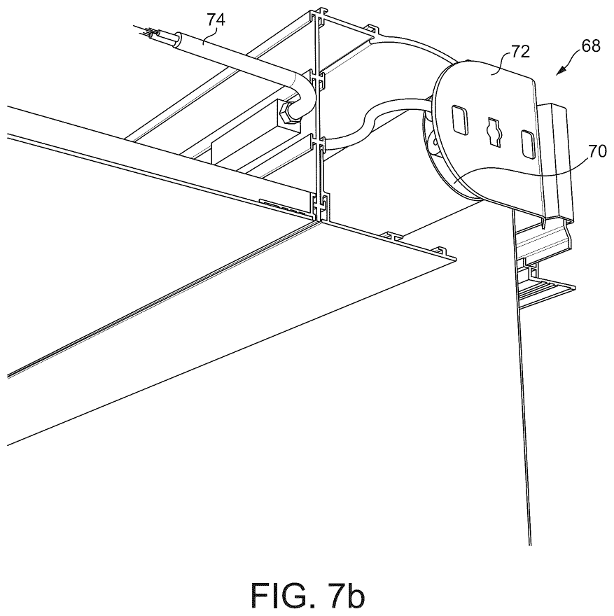

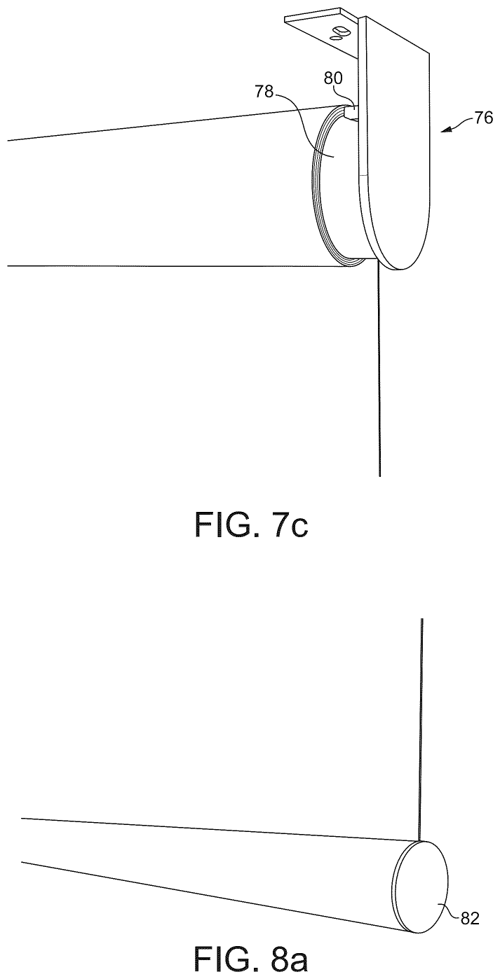

The sheet material portion 22 is deployable by rotation about its axis 24. Various actuating mechanisms are illustrated in FIGS. 7a-c that may be employed to induce this rotation. FIG. 7a illustrated a manually driven actuating mechanism 60 comprising an elongate member in the form of a beaded chain loop 62 in mechanical communication with a gear 64 located within a gear housing 66. The gear 64 is mounted with an end plate of the roll 22. Pulling one end of the chain loop 62 induces rotation of the gear, and therefore the roll 22, in a first direction, unravelling the roll and deploying the sheet material portion 22. Pulling on the other end of the loop 62 reverses the effect, ravelling the roll 22 and retracting the sheet material portion 22 towards the housing 20. The mechanism 60 may be mounted within the housing 20, with the chain 62 passing through an opening of the same to be accessible to a user. Alternatively, the roll 22 may pass through the end of the housing 22 to be partially exposed such that the mechanism 60 may be freely accessible.

FIG. 7b illustrates a motorised actuating mechanism 68 including a motor 70 mounted to a mounting plate 72 and in mechanical communication with the roll 22 to allow rotation of the same. The motor is supplied by a wired connection 74 in the form of a flexible cable. The motor 70 may be controlled by a remote control or by a wall switch. FIG. 7c illustrates another motorised actuating mechanism 76 including a wireless motor 78 operating similarly to the mechanism illustrated in FIG. 7b. The motor 78 includes a battery and is controlled by a remote control. Alternatively, the motor may include appropriate input components to allow the motor to be voice activated or the like. The motor 78 includes a charging port 80 to allow the internal battery to be charged from a separate power source, such as a portably power bank via a USB connection for example. Alternatively, the internal battery may be replaceable by an end user.

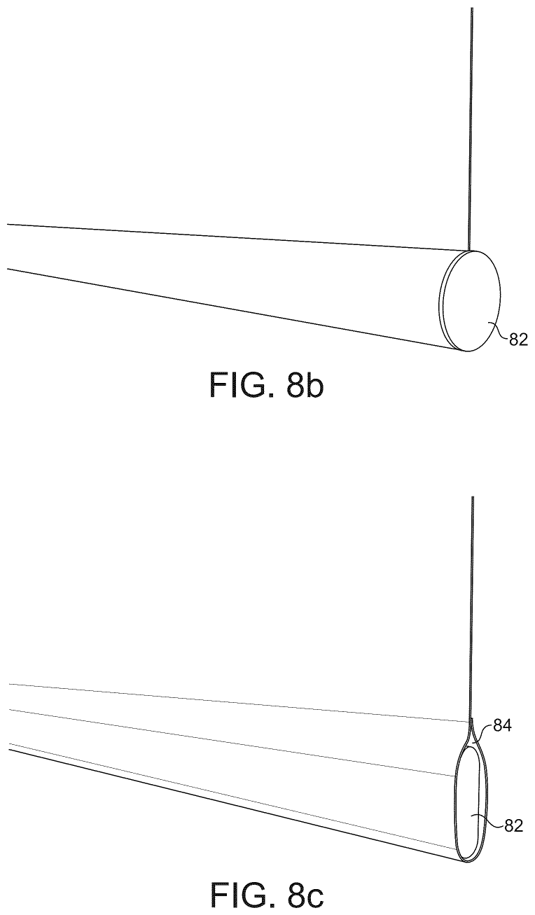

The sheet material portion 22 includes a weight 82 to anchor the same located at the free end 26 of the sheet material portion, reducing the extent to which the sheet material portion 22 will be displaced by wind or other external forces. FIGS. 8a-c illustrate various embodiments of the weight 82. FIGS. 8a-b illustrate an exposed weight 82 comprising a silver anodised weight and custom powder coated weight respectively. FIG. 8c illustrates a weight 82 concealed within a pocket 84 of the sheet material portion.

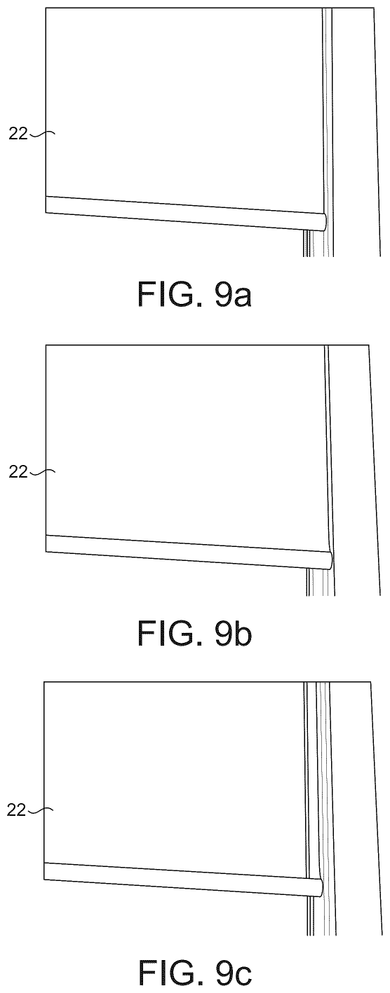

The sheet material portion 22 is formed of a flexible fabric material, which may be provided in various materials and/or thread densities. FIGS. 9a-c illustrate various fabrics with varying materials and/or thread densities to provide varying degrees of opacity. FIG. 9a illustrates a substantially opaque sheet material portion formed of an opaque sheet material, suitable for blackout sheet material portions to give zero light transmittance. This sheet material portion is suitable for bedrooms. FIG. 9b illustrates a translucent sheet material portion formed of a woven fabric, with a thread density suitable to allow direct sunlight through but significantly reduces any other light source transmittance. This is suitable for privacy blinds, whilst still allowing some degree of light through and is suitable for living spaces. FIG. 9c illustrates a sheet material portion formed of an open weave material to control glare therethrough, without completely blocking the view through a window.

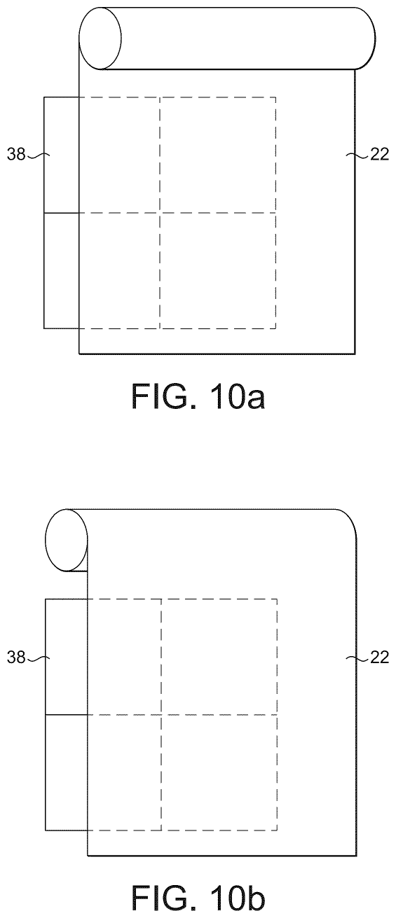

FIGS. 10a-b illustrate a first and second configuration of a sheet material portion 22 with respect to a window 38 with which the blind assembly is located. In the first configuration, illustrated in FIG. 10a, the sheet material portion is provided in a forward roll, wherein the sheet material portion rolls off the roll on the side closest to the window. This provides the greatest degree of light reduction as there is less of a gap between the roll and the window 38. FIG. 10b illustrates the second configuration, wherein the roll is provided as a reverse roll, the roll rolling off the side of the roll furthest from the window. This provides greater clearance from the window, allowing clearance for inwardly opening windows and their features, such as handles or the like.

In alternative embodiments, the sheet material portion 22 may be provided in a folded configuration within the housing 20, deployed by unfolding the sheet material portion. In these embodiments, the sheet material portion is folded back on itself in a corrugated manner. The sheet material portion may include an extending member located along its length in the deploying direction which is actuatable by an actuating means to extend and retract the sheet material portion.

As such, there is provided a sheet material portion that is sealed within a housing during the installation of the same with a ceiling and/or wall unit. The sheet material portion is protected from damage that may otherwise occur during the fitting of a room in which the blind assembly is to be located, such as painting, electrical installation or the like that may be carried out after the blind assembly has been installed. This allows the assembly to be installed in one process and unsealed by an untrained end user of the assembly.

1. A blind assembly including: a housing; a sheet material portion located within the housing along with an actuation means which is configured to be used to selectively deploy the sheet material portion between retracted and extended positions and intermediate positions through an opening of the housing unit; a mounting means to allow the blind assembly to be installed in position with a ceiling and/or wall of a building and wherein the said sheet material portion is retained within the said housing during said installation of the blind assembly at the ceiling and/or wall of a building.

2. A blind assembly according to claim 1 wherein a sealing means is provided across at least a portion of the opening after the blind assembly has been formed so as to retain the sheet material portion in the housing.

3. A blind assembly according to claim 2 wherein the said blind assembly is formed under factory conditions and the sealing means are applied and the apparatus is then transported to the location of installation and installed in that format.

4. A blind assembly according to claim 2 wherein the sealing means substantially seals the opening and so closes the same to protect the sheet material portion from the ingress of dust, debris and liquid into the interior of the said housing in which the sheet material portion is located.

5. A blind assembly according to claim 4 wherein the sealing means seals the opening of the housing to encapsulate at least the sheet material portion within the housing.

6. A blind assembly according to claim 2 wherein the sealing means includes a sealing member adhered to the housing.

7. A blind assembly according to claim 5 wherein the sealing means is a member located with the housing by a frangible connection which can be broken to remove the sealing means and allow movement of the sheet material portion through the opening.

8. A blind assembly according to claim 7 wherein the sealing member cannot be relocated with the housing once the same has been removed therefrom and so is tamper evident.

9. A blind assembly according to claim 2 wherein the sealing means includes a tab to enable the user to remove the sealing means from the housing by gripping the tab and then applying a force to remove the sealing means from the housing.

10. A blind assembly according to claim 2 wherein the housing is provided with sealing means in the form of at least one movable panel configured such that the sheet material portion is accessible when in the retracted configuration and when the at least one movable panel has been moved to an access position.

11. A blind assembly according to claim 10 wherein the housing includes a flange member configured such that the at least one movable panel and/or a wall panel may be located against the same in use such that the panel is substantially flush with the face of the housing in which the opening through which the sheet material portion is selectively deployable in use is located.

12. A blind assembly according to claim 2 wherein the said sheet material portion is provided in the retracted configuration within the housing until the said sealing means is removed once the blind assembly and/or building in which the same is installed, is ready for use.

13. A blind assembly according to claim 1 wherein the said actuation means includes a spindle around which the sheet material portion is rolled when in the retracted configuration and from which the sheet material is progressively unwound as it is moved to the extended configuration and wound as the sheet material portion is moved to the retracted configuration by rotation of the spindle.

14. A blind assembly according to claim 13 wherein the spindle is mounted with respect to the housing and is rotatable with respect to the housing.

15. A blind assembly according to claim 14 wherein the sheet material portion is folded within the housing when in the retracted configuration in a corrugated manner and is acted upon by the actuation means to unfold and fold the same as the sheet material portion is moved to the extended configuration and to the retracted configuration respectively.

16. A blind assembly according to claim 1 wherein the actuation means includes a motorised mechanism electrically connected with a power source to cause movement of the mechanism and, in turn, the sheet material portion.

17. A blind assembly according to claim 16 wherein the power source is a battery and includes an electrical input port to allow the same to be selectively chargeable in situ.

18. A blind assembly according to claim 1 wherein the housing includes a locating means for a curtain.

19. A blind assembly according to claim 1 wherein the blind assembly is utilised as a means to allow selective masking of the passage of light through a window with respect to which the blind assembly is adjacently installed.

20. A method of installing a blind assembly, the method comprising the steps of locating a housing of the blind assembly with a wall and/or ceiling of a building and installing the assembly via retaining means to the said wall and/or ceiling, wherein the said blind assembly is assembled prior to said installation by locating a sheet material portion of the blind assembly in a retracted configuration in engagement with actuation means located within the interior of said housing and retaining the same within the said housing during installation, and after said installation allowing said sheet material portion to be selectively deployable between a retracted configuration and an extended configuration through an opening of the housing.

21. A method according to claim 20 wherein the method further includes a step of applying a sealing means to seal the opening of the housing once the blind assembly is formed and so retain and seal the sheet material portion within the housing prior to installation and then removing the sealing means after installation to allow the sheet material portion to be moved through the opening.
